(19) United States
(12) Patent Application Publication
(10) Pub. No.: US 2024/0278682 A1
(43) Pub. Date: Aug. 22, 2024

(54) VEHICLE MANAGEMENT DEVICE

(71) Applicant: TOYOTA JIDOSHA KABUSHIKI KAISHA, Toyota-shi (JP)

(72) Inventors: Shoichi IWAMOTO, Fuji-shi (JP); Hisashi Fujisawa, Toyota-shi (JP); Hiroyuki Ogura, Ama-shi (JP); Yoshinobu Nozaki, Anjo-shi (JP); Hideo Sakamoto, Toyota-shi (JP); Yasunobu Seki, Nisshin-shi (JP); Mitsuaki Tomita, Toyota-shi (JP)

(73) Assignee: TOYOTA JIDOSHA KABUSHIKI KAISHA, Toyota-shi (JP)

(21) Appl. No.: 18/543,219

(22) Filed: Dec. 18, 2023

(30) Foreign Application Priority Data
Feb. 22, 2023 (JP) 2023-026645

(51) Int. Cl. B60L 55/00; B60L 53/51; H02J 3/32; H02J 3/38; H02J 7/35

(52) U.S. Cl. CPC B60L 55/00; B60L 53/51; H02J 3/322; H02J 3/38; H02J 7/35; B60L 2250/00; H02J 2300/24

(57) ABSTRACT

The vehicle management device includes a drive unit for driving, a power storage device that can supply power to the drive unit, and a solar cell system that can generate electricity from a solar cell and supply it to the power storage device, and also supplies power to the outside of the vehicle. Vehicles that can be used. While the vehicle is parked, the vehicle management device sets an allowable power supply amount for the outside of the vehicle within the range of the predicted power generation amount of the solar cell until the next scheduled start time of the vehicle.

### CROSS-REFERENCE TO RELATED APPLICATION

This application claims priority to Japanese Patent Application No. 2023-026645 filed on Feb. 22, 2023, incorporated herein by reference in its entirety.

### BACKGROUND

### 1. Technical Field

The present disclosure relates to a vehicle management device.

### 2. Description of Related Art

Hitherto, as a vehicle management device to be used for a vehicle whose drive battery is charged with electric power generated by a solar power generation device (solar panel), there has been proposed a vehicle management device in which an available amount for a device outside a vehicle is calculated based on electric power generated by a solar power generation device mounted on the vehicle and is displayed on a display unit (see, for example, Japanese Unexamined Patent Application Publication No. 2022-135767 (JP 2022-135767 A)).

### SUMMARY

Such a vehicle has a problem in how to set an allowable power supply amount for the outside of the parked vehicle. This is because the power storage ratio of the drive battery decreases and the amount of electric power for the next travel decreases as the amount of electric power supplied to the outside of the parked vehicle increases.

The main object of the vehicle management device of the present disclosure is to more appropriately set the allowable power supply amount for the outside of the parked vehicle.

The vehicle management device of the present disclosure employs the following measures to achieve the main object.
[1] The vehicle management device of the present disclosure is
a vehicle management device to be used for a vehicle including a drive unit for travel, a power storage device configured to supply electric power to the drive unit, and a solar cell system configured to generate electric power by a solar cell and supply the electric power to the power storage device. The vehicle is configured to supply the electric power to an outside of the vehicle.
The vehicle management device is configured to set an allowable power supply amount for the outside of the vehicle while the vehicle is parked within a range of a predicted power generation amount of the solar cell until a next scheduled travel start time.

In the vehicle management device of the present disclosure, the allowable power supply amount for the outside of the vehicle is set while the vehicle is parked within the range of the predicted power generation amount of the solar cell until the next scheduled travel start time. Thus, it is possible to suppress a decrease in the power storage ratio of the power storage device while the vehicle is parked and suppress a decrease in the amount of electric power for the next travel. That is, it is possible to more appropriately set the allowable power supply amount for the outside of the parked vehicle.
[2] In the vehicle management device of the present disclosure (vehicle management device according to [1]),
the vehicle management device may be configured to set the allowable power supply amount within the range of the predicted power generation amount when the vehicle participates in a virtual power plant (VPP) (the vehicle is permitted for use as the virtual power plant), and set the allowable power supply amount within an expanded range larger than the predicted power generation amount when the vehicle does not participate in the virtual power plant (the vehicle is not permitted for use as the virtual power plant).
Thus, when the vehicle participates in the virtual power plant, electric power can be supplied to the outside of the vehicle (power system) within a range of the amount of electric power generated by using natural energy. When the vehicle does not participate in the virtual power plant, the amount of electric power supplied to the outside of the vehicle can be increased in response to a request from the outside of the vehicle.
[3] In the vehicle management device of the present disclosure (vehicle management device according to [1]),
the vehicle management device may be configured to notify a user about the allowable power supply amount to allow the user to change the allowable power supply amount. Thus, the user can change the allowable power supply amount.
[4] In this case (vehicle management device according to [3]),
the vehicle management device may be configured to notify the user together with information as to whether the vehicle participates in a virtual power plant. Thus, the user can change the allowable power supply amount in consideration of whether the vehicle participates in the virtual power plant.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of an electric power system 10 including a vehicle 20 equipped with a vehicle management device according to the present embodiment;

FIG. 2 is a flowchart showing an example of an allowable power supply amount setting routine; and

FIG. 3 is a flowchart illustrating an example of an allowable power supply amount setting routine.

### DETAILED DESCRIPTION OF EMBODIMENTS

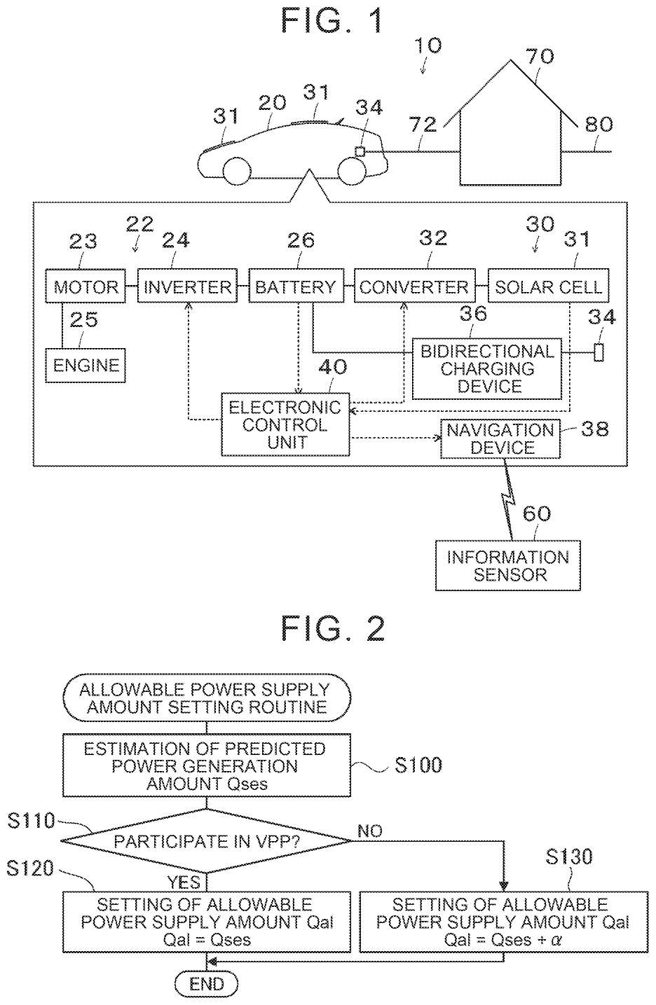

Embodiments of the present disclosure will be described with reference to the drawings. FIG. 1 is a schematic configuration diagram of an electric power system 10 including a vehicle 20 equipped with a vehicle management device according to the present embodiment. As illustrated, the electric power system 10 includes a vehicle 20, a house 70, and a power system 80. The vehicle 20 is configured as a hybrid electric vehicle, and includes a drive unit 22, a battery 26 as a power storage device, a solar cell system 30, a connector 34, a bidirectional charging device 36, a navigation device 38, and an electronic control unit 40. The electronic control unit 40 corresponds to the vehicle management device of this embodiment.

The drive unit 22 includes a motor 23, an inverter 24, and an engine 25. The motor 23 is configured as a synchronous generator-motor, and is capable of generating electricity using the power from the engine 25 and outputting power for driving. The inverter 24 is used to drive the motor 23 and is connected to the battery 26 via the power line. Note that instead of the motor 23 and the inverter 24, a generator capable of generating electricity using the power from the engine 25, a motor capable of outputting power for running, and two inverters each driving the generator and the motor may be included. The battery 26 has a plurality of secondary battery cells configured as lithium-ion secondary batteries or nickel-hydrogen secondary batteries.

Solar cell system 30 has a solar cell 31 and a converter 32. The solar cell 31 has a plurality of solar cells and is fixed to the upper surface of the roof of the vehicle body, the upper surface of the hood, or the like. Converter 32 supplies the power generated by solar cell 31 to battery 26 with voltage conversion.

The connector 34 can be connected to a house 70 via a relay cable 72. Here, the house 70 is connected to the power system 80 and can receive power from the power system 80 or supply power to the power system 80.

When the connector 34 and the house 70 are connected via the relay cable 72, the bidirectional charging device 36 is also possible to supply power from the house 70 to the battery 26, and supply power from the battery 26 to the house 70 or to the power system 80 via the house 70.

When the destination is set, the navigation device 38 sets the travel route from the current location to the destination based on the map information and the current location of the vehicle 20 and the destination detected by the GPS, and displays it on the display, and thus performs route guidance. Navigation device 38 is in communication with electronic control unit 40. The navigation device 38 communicates with an information center 60 outside the vehicle 20, transmits the current location of the vehicle 20 to the information center 60, and also receives sunshine information (weather, sunrise and sunset time, etc.) of the current location of the vehicle 20 from the information center 60.

The electronic control unit 40 has a microcomputer, and the microcomputer has a CPU, ROM, RAM, flash memory, input/output ports, and communication ports. The electronic control unit 40 receives signals from various sensors through input ports. The signals input by the electronic control unit 40 include, for example, the voltage Vb and current Ib of the battery 26, the voltage Vs1 and current Is1 on the solar cell 31 side of the converter 32, the voltage Vs2 and current Is2 on the battery 26 side of the converter 32, and the like. The electronic control unit 40 outputs various control signals through output ports. Examples of the signal output by the electronic control unit 40 include a control signal to the drive unit 22, a control signal to the converter 32, a control signal to the warning light 42, and the like. The electronic control unit 40 calculates the power storage ratio SOC of the battery 26 based on the integrated value of the current Ib of the battery 26, and the power generation of the solar cell 31 based on the voltage Vs1 and the current Is1 on the solar cell 31 side of the converter 32. It also calculates the electric power Ps. Electronic control unit 40 is in communication with navigation device 38 as described above.

Next, the operation of the electric power system 10 of the present embodiment will be explained, in particular, the vehicle 20 and the house 70 are connected via the relay cable 72, and power is supplied from the vehicle 20 to the outside of the vehicle (the house 70 and the power system 80). This section describes the operation when external power supply is permitted. FIG. 2 is a flowchart showing an example of an allowable power supply amount setting routine executed by the electronic control unit 40 of the vehicle 20. This routine is executed when the vehicle 20 and the house 70 are connected via the relay cable 72 and external power supply is permitted.

When the allowable power supply amount setting routine of FIG. 2 is executed, the electronic control unit 40 estimates the predicted power generation amount Qses of the solar cell 31 up to the next scheduled travel start time (S100). Here, the scheduled travel start time is set by the user, for example. Note that when the parking spot is at home or the like, the scheduled travel start time may be set based on a history of travel start times. The process of S100 is, for example, based on the sunlight information (weather, sunrise and sunset times, etc.) from the information center 60, and calculates the predicted sunlight for a predetermined period from the current time at the current location of the vehicle 20 to the next scheduled start time. This can be done by estimating the predicted amount of sunlight Qss and estimating the predicted power generation amount Qses of the solar cell 31 for a predetermined period at the current location of the vehicle 20 based on the estimated predicted amount of sunlight Qss.

After estimating the predicted power generation amount Qses of the solar cell 31 in this way, it is determined whether the vehicle 20 is participating in a Virtual Power Plant (hereinafter referred to as “VPP”) (S110). Here, whether or not the vehicle 20 participates in the VPP means whether or not the use of the vehicle 20 as a VPP is permitted. Whether or not the vehicle 20 participates in VPP is set in advance by the user.

When it is determined in S110 that the vehicle 20 is participating in VPP, the predicted power generation amount Qses of the solar cell 31 is set to the allowable power supply amount Qa1 from the vehicle 20 to the outside of the vehicle (the house 70 and the power system 80) (S120), this routine ends. When the allowable power supply amount Qa1 is set in this manner, electric power is supplied from the vehicle 20 to the outside of the vehicle (the house 70 and the power system 80) within the range of the allowable power supply amount Qa1 until the next scheduled travel start time. Note that the power supply from the vehicle 20 to the house 70 is performed, for example, in response to a request from the management department of the house 70, and the power supply from the vehicle 20 to the power system 80 via the house 70 is performed, for example, by using the power system 80. This is done in response to requests from the managing aggregator.

Thereby, power can be supplied from the vehicle 20 to the outside of the vehicle (the house 70 and the power system 80) within the range of the power generation amount of the solar cell 31. As a result, it is possible to suppress the decrease in the power storage ratio SOC of the battery 26 during parking and the decrease in the amount of electric power for the next run. Further, when the vehicle 20 participates in VPP, when supplying natural energy power, which is power generated using natural energy such as sunlight, to the power system 80, incentives can be obtained compared to supplying other power (for example, power generated by the motor 23 using the power from the engine 25) to the power system 80, in some cases. When the vehicle 20 participates in VPP, such an incentive can be obtained by setting the predicted power generation amount Qses of the solar cell 31 to the allowable power supply amount Qa1.

When it is determined in S110 that the vehicle 20 does not participate in VPP, the allowable power supply amount Qa1 is set to the value obtained by adding the correction value α to the predicted power generation amount Qses of the solar cell 31 (S130), and this routine ends. Thereby, power can be supplied from the vehicle 20 to the outside of the vehicle (the house 70) beyond the range of the power generation amount of the solar cell 31. As a result, the amount of power supplied to the outside of the vehicle can be increased in response to requests from outside the vehicle. Here, as the correction value α, for example, the amount of power that can be discharged from the battery 26 based on the power storage ratio SOC of the battery 26 or a value that is somewhat smaller than that can be used.

In either case, external charging is performed to charge the battery 26 of the vehicle 20 using the power supplied from the power system 80 via the house 70 and the relay cable 72 until the next scheduled start time of travel. It can also be used as a thing.

In the electronic control unit 40 as the vehicle management device of the present embodiment described above, when the vehicle 20 participates in VPP, the predicted power generation amount Qses of the solar cell 31 up to the next scheduled start time is set as the allowable power supply amount Qa1, and when the vehicle 20 is not participating in VPP, the allowable power supply amount Qa1 is set to the value obtained by adding the correction value α to the predicted power generation amount Qses of the solar cell 31. Thereby, when the vehicle 20 participates in VPP, power can be supplied from the vehicle 20 to the outside of the vehicle (the house 70 and the power system 80) within the range of the predicted power generation amount Qses of the solar cell 31. As a result, it is possible to suppress the decrease in the power storage ratio SOC of the battery 26 during parking and the decrease in the amount of electric power for the next run. In addition, incentives may be obtained by supplying power using natural energy to the power system 80. On the other hand, when the vehicle 20 is not participating in VPP, power can be supplied from the vehicle 20 to the outside of the vehicle (the house 70) within an expanded range that is larger than the predicted power generation amount Qses of the solar cell 31. As a result, the amount of power supplied to the outside of the vehicle can be increased in response to a request from outside the vehicle (house 70).

In the embodiment described above, when the vehicle 20 participates in VPP, the electronic control unit 40 sets the predicted power generation amount Qses of the solar cell 31 until the next scheduled travel start time to the allowable power supply amount Qa1. However, the present disclosure is not limited to this, and the allowable power supply amount Qa1 may be set within the range of the predicted power generation amount Qses of the solar cell 31.

In the embodiment described above, when the vehicle 20 is not participating in VPP, the electronic control unit 40 sets the allowable power supply to the value obtained by adding the correction value α to the predicted power generation amount Qses of the solar cell 31 until the next scheduled start time. The allowable power supply amount Qa1 shall be set. However, the present disclosure is not limited to this, and the allowable power supply amount Qa1 may be set within an expanded range larger than the predicted power generation amount Qses of the solar cell 31.

In the embodiment described above, when the vehicle 20 participates in VPP, the electronic control unit 40 sets the predicted power generation amount Qses of the solar cell 31 until the next scheduled travel start time to the allowable power supply amount Qa1, and the vehicle 20 is not participating in VPP, the allowable power supply amount Qa1 is set to the value obtained by adding the correction value α to the predicted power generation amount Qses of the solar cell 31. However, regardless of whether the vehicle 20 participates in VPP or not, the allowable power supply amount Qa1 may be set within the range of the predicted power generation amount Qses of the solar cell 31.

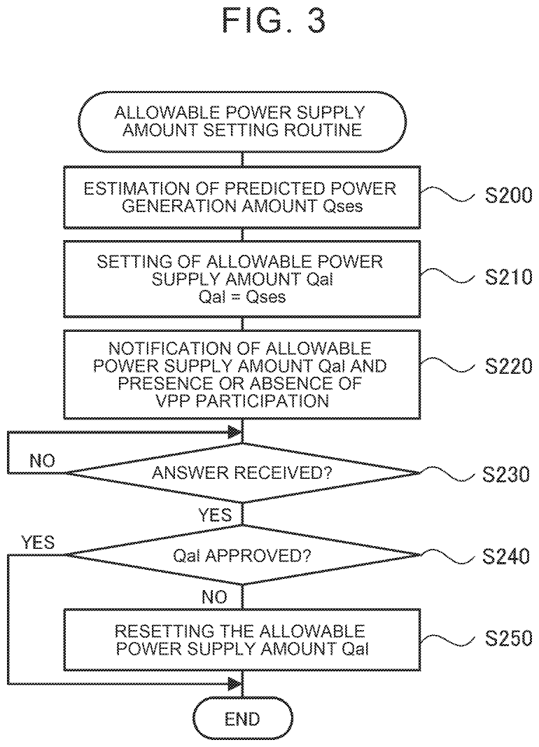

In the embodiment described above, the electronic control unit 40 executes the allowable power supply amount setting routine shown in FIG. 2. However, instead of this, the electronic control unit 40 may execute the allowable power supply amount setting routine shown in FIG. 3.

In the allowable power supply amount setting routine of FIG. 3, the electronic control unit 40 first estimates the predicted power generation amount Qses of the solar cell 31 up to the next scheduled running start time, similar to the process of S100 of the allowable power supply amount setting routine of FIG. 2 (S200). Next, the estimated predicted power generation amount Qses of the solar cell 31 is set as the allowable power supply amount Qa1 (S210), the set allowable power supply amount Qa1 and the presence or absence of VPP participation are notified to the user (S220), and the user's request is It waits for a response to be received (S230). Here, the process of S220 includes necessary information so that the user can, for example, select whether to approve the allowable power supply amount Qa1, and set a desired value when the allowable power supply amount Qa1 is not approved. This can be done by displaying on the display of the navigation device 38 or on the display of a preset mobile terminal (smartphone, tablet terminal, etc.). The desired value may be set freely by the user, or may be selected from a plurality of candidates.

Then, upon receiving the response from the user, it is determined whether the user has approved the allowable power supply amount Qa1 (S240). When it is determined that the user has approved the allowable power supply amount Qa1, this routine ends.

When it is determined in S240 that the user has not approved the allowable power supply amount Qa1, the desired value set by the user is reset as the allowable power supply amount Qa1 (S250), and this routine ends. Thereby, the user can approve or change the allowable power supply amount Qa1 in consideration of whether or not the user participates in VPP.

In the allowable amount setting routine of FIG. 3, the electronic control unit 40 notifies the user of the allowable power supply amount Qa1 set in S210 and whether VPP is participating. However, the electronic control unit 40 may notify the user only of the allowable power supply amount Qa1.

In the embodiment described above, the battery 26 is used as the power storage device, but instead of this, a capacitor or the like may be used.

In the embodiment described above, the vehicle 20 is provided with a drive unit 22 having a motor 23 and an engine 25, a battery 26, and a solar cell system 30. However, the present disclosure is not limited to this, and any structure may be used as long as it includes the drive unit 22, the battery 26, and the solar cell system 30. For example, the drive unit 22 may not include the engine 25.

The correspondence relationship between the main elements of the embodiments and the main elements of the disclosure described in the column of Means for Solving the Problems will be described. In the embodiment, the drive unit 22 corresponds to the “drive unit”, the battery 26 corresponds to the “power storage device”, the solar cell system 30 corresponds to the “solar cell system”, the vehicle 20 corresponds to the “vehicle”, and the electronic control unit 40 corresponds to the “vehicle management device”.

Note that the correspondence relationship between the main elements of the embodiment and the main elements of the disclosure described in the column of Means for Solving the Problem indicates that the embodiment implements the disclosure described in the column of Means to Solve the Problem. Since it is an example for specifically explaining the mode for solving the problem, it does not limit the elements of the disclosure described in the column of the means for solving the problem. That is, the interpretation of the disclosure described in the column of Means to Solve the Problem should be made based on the description in that column, and the embodiment should be based on the description of the disclosure described in the column of Means to Solve the Problem. This is only a specific example.

Although the embodiments for carrying out the present disclosure have been described above, the present disclosure is not limited to such embodiments in any way, and it goes without saying that the present disclosure can be implemented in various forms without departing from the gist of the present disclosure.

The present disclosure is applicable to the manufacturing industry of vehicle management devices and the like.

What is claimed is:

1. A vehicle management device to be used for a vehicle including a drive unit for travel, a power storage device configured to supply electric power to the drive unit, and a solar cell system configured to generate electric power by a solar cell and supply the electric power to the power storage device, the vehicle being configured to supply the electric power to an outside of the vehicle, wherein the vehicle management device is configured to set an allowable power supply amount for the outside of the vehicle while the vehicle is parked within a range of a predicted power generation amount of the solar cell until a next scheduled travel start time.

2. The vehicle management device according to claim 1, wherein the vehicle management device is configured to set the allowable power supply amount within the range of the predicted power generation amount when the vehicle participates in a virtual power plant, and set the allowable power supply amount within an expanded range larger than the predicted power generation amount when the vehicle does not participate in the virtual power plant.

3. The vehicle management device according to claim 1, wherein the vehicle management device is configured to notify a user about the allowable power supply amount to allow the user to change the allowable power supply amount.

4. The vehicle management device according to claim 3, wherein the vehicle management device is configured to notify the user together with information as to whether the vehicle participates in a virtual power plant.
